(19) United States
(12) Patent Application Publication
(10) Pub. No.: US 2018/0130008 A1
(43) Pub. Date: May 10, 2018

(54) System and Method for Aerial Vehicle Automatic Landing and Cargo Delivery

(71) Applicant: Yan Liu, Verona, NJ (US)

(72) Inventor: Yan Liu, Verona, NJ (US)

(21) Appl. No.: 15/344,556

(22) Filed: Nov. 6, 2016

(51) Int. Cl. G06Q 10/08; B64C 39/02; B64D 47/08; G06K 7/14; G06K 19/06

(52) U.S. Cl. CPC G06Q 10/083; B64C 39/024; B64C 2201/128; G06K 7/1413; G06K 19/06112; B64D 47/08

(57) ABSTRACT

An aerial vehicle equipped with a barcode reading sensor can initiate a landing process or cargo delivery process after reading preconfigured data from a barcode. The data configured in the barcode contains various forms of information including but not limited to GPS coordinates, barcode directions, identifications, size of the barcode, batter charging capabilities. This information can be used by the aerial vehicle how and where to land or deliver the cargo carried by the aerial vehicle, the aerial vehicle may also use this information to perform other tasks.

### BACKGROUND OF INVENTION

The present invention is in the technical field of automatic landing and cargo delivery by aerial vehicle. More particularly, the present invention is in the technical field of drone automatic landing and cargo delivery.

Aerial vehicles, especially unmanned aerial vehicles are valuable tools in many applications, particularly aerial photography, surveillance and cargo delivery. Typically, aerial vehicles such as drones are remote controlled, thus it is difficult for aerial vehicles to land or deliver a cargo onto some complicated area, such as in the downtown of cities or a landing stations over a mountain. There are many challenges in the autonomous landing or delivery process of an aerial vehicle, such as:
a. Determine the precise location and height of the aerial vehicle reliably
b. Determine the precise landing direction
c. Identifying the landing or delivery location or station
d. Authenticating the landing location or station information
e. Protecting the information of the landing or delivery station

Current methods mostly rely on GPS to guide the landing process, some further use LEDs to guide the landing process, however these methods could not solve all those challenges described above.

### SUMMARY OF INVENTION

The present invention is a system and method for aerial vehicle automatic landing and cargo delivery, particularly drones.

### BRIEF DESCRIPTION OF THE DRAWINGS

FIG. 1 is a perspective view of an aerial vehicle reading a barcode on the ground and preparing for landing.

FIG. 2 is a perspective view of an aerial vehicle carrying a cargo reading a barcode on the ground and preparing for landing or deliver the cargo.

FIG. 3 is a perspective view of an internet connected aerial vehicle reading a barcode displayed on a screen of an internet connected client computer and preparing to deliver the cargo or landing.

FIG. 4 is a perspective view of an internet connected aerial vehicle reading a barcode displayed on a screen of an internet connected client computer, the screen and computer are carried by a pickup truck, and the aerial vehicle is preparing to deliver the cargo onto the pickup truck or landing on the pickup truck.

FIG. 5 is a perspective view of photographic magnification of thin lens camera.

### DETAIL DESCRIPTION OF THE INVENTION

The present invention will be described in connection with preferred embodiments; however, it will be understood that there is no intent to limit the present invention to the embodiments described herein. On the contrary, the intent is to cover all alternatives, modifications, and equivalents as may be included within the present invention as defined by the claims.

For a general understanding of the present invention, reference is made to the drawings. In the drawings, references have been used throughout to designate identical or equivalent elements. It is also noted that the various drawings illustrating the present invention are not drawn to scale and that certain regions have been purposely drawn disproportionately so that the features and concepts of the present invention could be properly illustrated.

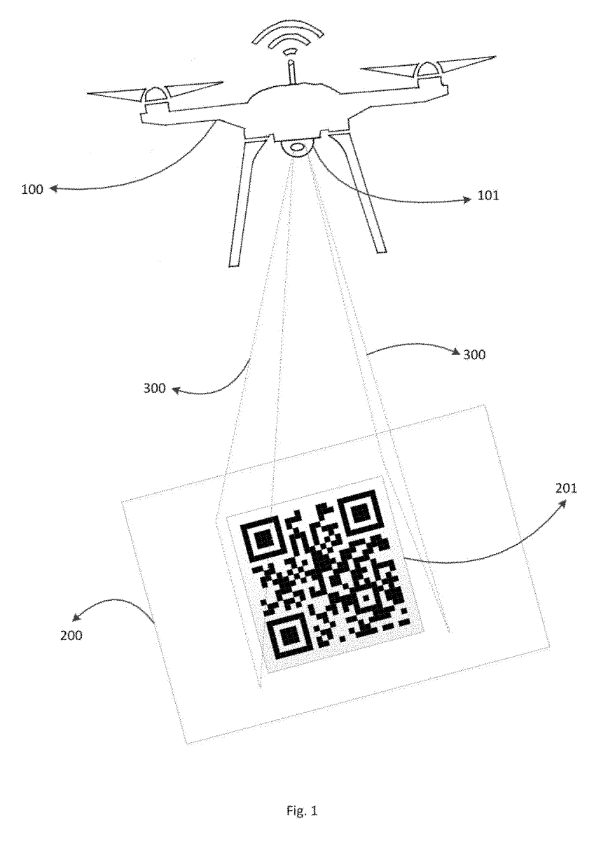

Referring now to the present invention in more detail in FIG. 1, an aerial vehicle or a drone 100, having a sensor or a camera 101 flying above the ground 200, is shown. A barcode or particularly a 2-dimentional barcode 201 printed or attached on the ground 200 is shown. It is noted that a 2-dimentional barcode is preferred than a 1-dimensional barcode, because 2-dimensional barcode can represent more data per unit area than 1-dimensional barcode. The essential approach of the present invention is to detect, scan or read 300 the barcode 201 by the drone 100 camera 101 to acquire data configured to the barcode 201. After the data has been acquired by the drone, the drone will then process the data by its processing unit such as a microcontroller. If the data configured to the barcode 201 meets the requirements by the drone 100, then the drone 100 could start a landing process. The drone may directly land onto the location of the barcode 201 or any place required by the data configured to the barcode 201, or the drone 100 may decide landing location by itself.

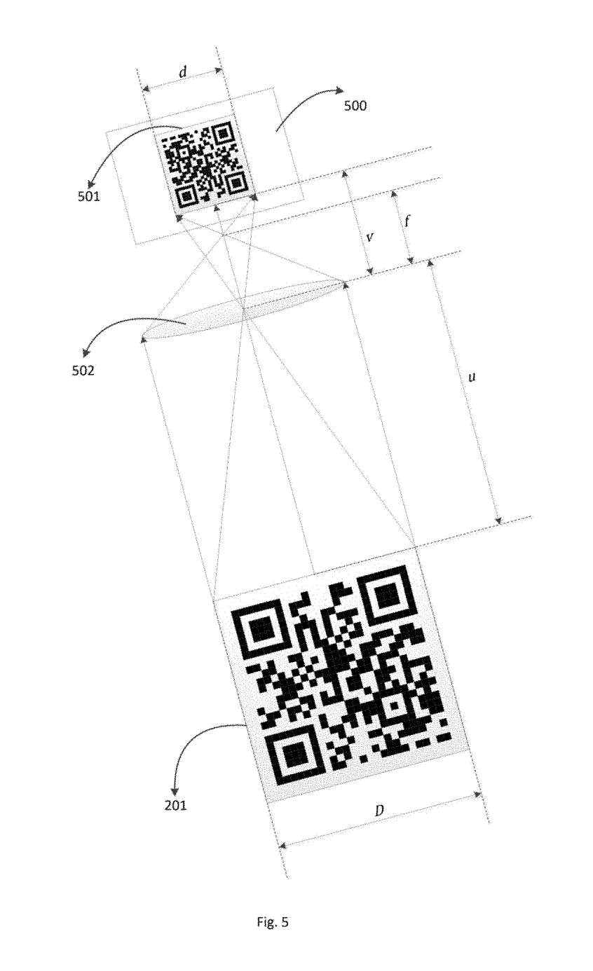

It is noted that various data could be configured to the barcode 201, including but not limited to GPS coordinates, barcode 201 directions, identifications, size of the barcode, battery charging capabilities. These data are critical to a drone's automatic landing. Perhaps the most important function for a drone to land automatically, is the location or GPS coordinates to land. In some scenarios, high precision landing is required, such as landing for battery charging. The state of the art GPS technology has a precision of about one meter; however, the battery charger may require a precision of 5 cm, in this case, for a drone 100 with a camera 101 scanning the barcode 201, an image 501 of the barcode 201 will be projected through lens 502 to the camera 101 image sensor 500, as shown in FIG. 5. If the distances from the object barcode 201 to the lens 502 and from the lens 502 to the image 501 are u and v respectively, for a lens of negligible thickness, in air, the distances are related by the thin lens formula:

$$\frac{1}{u} + \frac{1}{v} = \frac{1}{f}$$

where f is the focal length of the lens 502. Furthermore, if the width of the barcode 201 is D and the width of the image 501 is d, there is the photographic magnification formula that is traditionally presented as:

$$M = \frac{d}{D} = \frac{v}{u} = \frac{f}{u - f} = \frac{v - f}{f}$$

where M is the linear magnification of lens 502, and it is a constant.

It is noted that the actual camera may have more completed lens structure; however, there will always be a formula equivalent to the photographic magnification formula. Thus if the photographic magnification formula of camera 101 is known to the drone 100, the image 501 size and location on the image sensor 500 can further help drone 100 to determine the location and height related to the barcode 201. For security reasons, a drone 100 may need to know whether it is allowed to land on the ground 200, it is important that the data of barcode 201 contains identifications. Also, the data configured to the barcode 201 may be encrypted to prevent data disclosure. In some scenarios, the barcode 201 may be partially covered by hazards such as a bird, so it is best to apply error correction features to the barcode 201 so that even if the barcode 201 is partially covered, the drone 100 will still be able to read the barcode 201. It is noted that the number of barcode is not limited to one; multiple barcodes can be used together if needed.

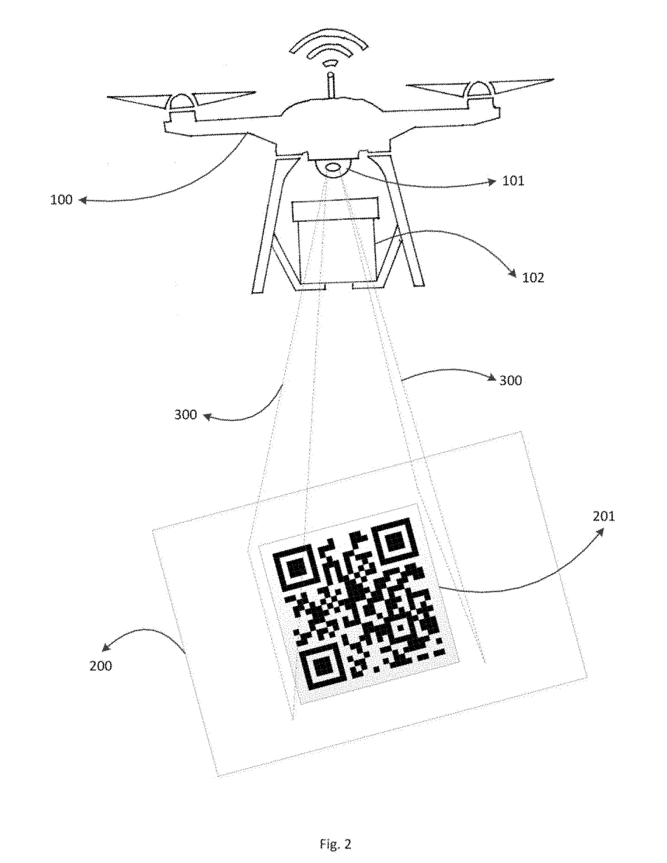

As illustrated in FIG. 2, the drone 100 may further be carrying a cargo 102. Thus when the drone 100 read 300 the barcode 201, instead of initiating a landing process, the drone 100 may initiate the cargo 102 delivery process according to the data configured to the barcode 201.

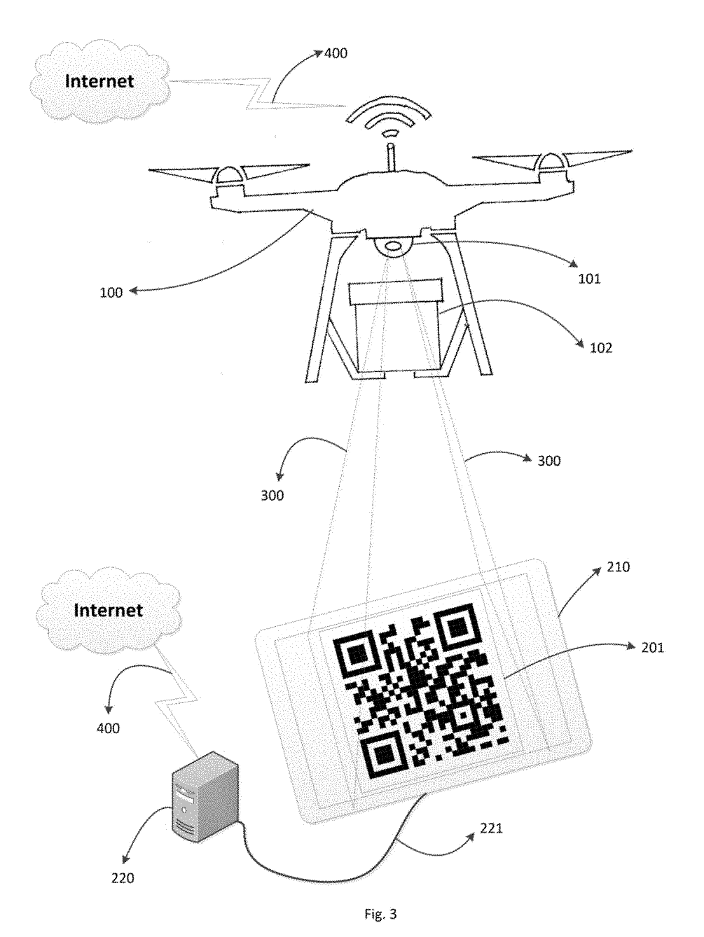

Referring now to the invention shown in FIG. 3.0, in a preferred embodiment, the drone 100 is further connected to the internet 400, and the barcode 201 now displays on a screen 210 connected via 221 to a client computer 220, the client computer 220 is also connected to internet 400. The advantages of the embodiment shown in FIG. 3 are as follows: the screen 210 can be controlled by the client computer 220 and consequently, the barcode 201 can be controlled when to be displayed; the data configured to the barcode 201 can be dynamically changed on demand; the screen can display a series of barcodes to present more data to the drone 100; since most display will emit light by itself, no extra lighting devices will be needed during night. These advantages provide better security to prevent data disclosure and give more flexibility to the reading 300 process. Moreover, after the reading process, the drone 100 can further send a process request over the internet 400 regarding the data configured in the barcode 201, and receive results over the internet 400 to determine the next move of the drone 100. It worth noting that the drone 100 can initiate the landing process, cargo 102 delivery process, or something else, the drone may also do nothing and leave.

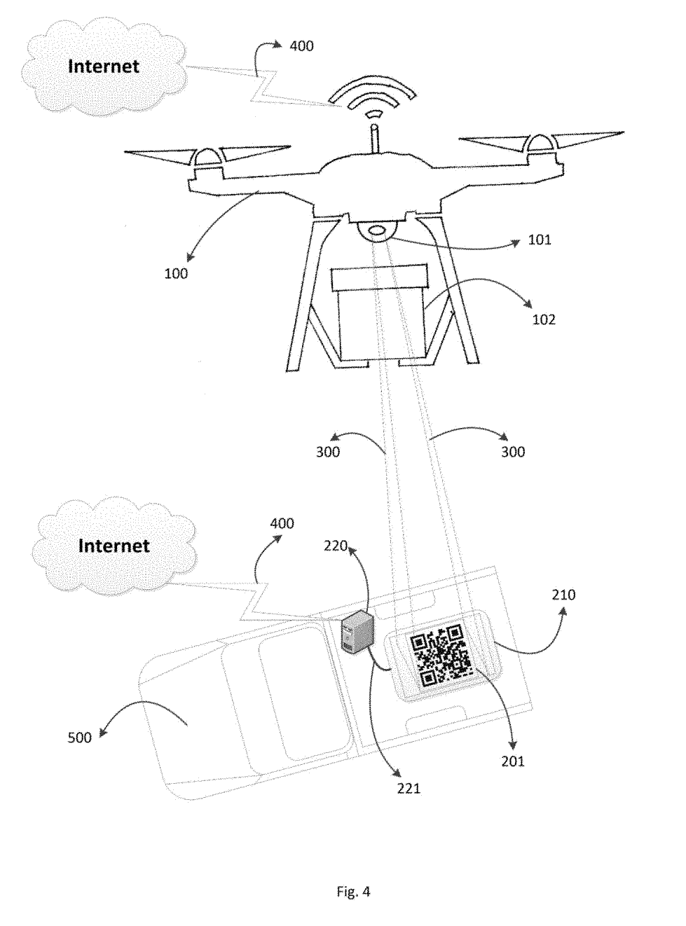

FIG. 4 illustrates another embodiment of the drone 100 landing on a car, such as a pickup truck 500, or deliver a cargo 102 to the pickup truck 500. The difficulties for the drone 100 to perform a job on the pickup truck 500 specially when the car is moving, is that the drone 100 needs to track the pickup's 500 location precisely in real time and accurately identify the pickup 500 from all the other cars on the road. Thus the barcode 201, with preconfigured data attached to the pickup truck 500, can be used by the drone 100 to precisely locate and accurately identify the pickup truck 500 in real time by scanning 300 the barcode continuously. For preferred embodiment, as shown in FIG. 4, the screen 210 is connected 221 to a client computer 220 carried by the pickup truck 500, the client computer 220 is connected to the internet 400. Thus the barcode 201 can be dynamically displayed on the screen 210, the drone 100 is also connected to the internet 400. Therefore, the embodiment illustrated in FIG. 4 provides the best security and flexibility for the drone 100 to track the pickup truck 500 precisely and accurately, since the drone 100 can initiate the landing process, cargo 102 delivery process or any process.

While various examples and embodiments of the present invention have been shown and described, it will be appreciated by those skilled in the art that the spirit and scope of the present invention are not limited to the specific descriptions and drawings herein, but extend to various modifications and changes all as set forth in the following claims.

CITATIONS
U.S. patent Documents

| | | |
|---|---|---|
| 7,871,044 | Jan. 18, 2011 | Hursig, et al. |
| 20120158222 A1 | Jun. 21, 2012 | Ehlin; Johan; et al. |
| 20140236390 A1 | Aug. 21, 2014 | Mohamadi; Farrokh |
| 9,429,953 | Aug. 30, 2016 | Miller, et al. |
| 9,448,562 | Sep. 20, 2016 | Sirang, et al. |
| 9,457,915 | Oct. 4, 2016 | Wang |

1. A system for Aerial Vehicle Automatic Landing or cargo delivery, comprising:
a barcode configured to store data; and
an aerial vehicle configured with a sensor to perform a read on the barcode.

2. A system for Aerial Vehicle Automatic Landing or cargo delivery, comprising:
a screen configured to display a barcode; and
an aerial vehicle configured with a sensor to perform a read on the barcode.

3. A system as recited of claim 1 or claim 2, further comprising;
a cargo wherein carried by the aerial vehicle.

4. A method for Aerial Vehicle Automatic Landing or cargo delivery, comprising:
reading barcode data with a senor wherein an aerial vehicle;
processing the barcode data by aerial vehicle computer;
landing the aerial vehicle or delivering cargo.

5. A method for Aerial Vehicle Automatic Landing or cargo delivery, comprising:
receiving at a client computer barcode data;
displaying the barcode on the client computer screen;
reading the data from the barcode with a senor wherein an aerial vehicle;
landing the aerial vehicle or delivering cargo.

6. A method as recited as claim 4 and claim 5, further comprising:
transmitting a barcode data processing request over the internet from the aerial vehicle;
receiving processing result over the internet from the aerial vehicle.
